(19) United States
(12) Patent Application Publication
(10) Pub. No.: US 2014/0032167 A1
(43) Pub. Date: Jan. 30, 2014

(54) Multisensor Management and Data Fusion via Parallelized Multivariate Filters

(71) Applicants: Peter Mayer, Malden, MA (US); David Manegold, Medford, MA (US)

(72) Inventors: Peter Mayer, Malden, MA (US); David Manegold, Medford, MA (US)

(73) Assignee: Physical Sciences, Inc., Andover, MA (US)

(21) Appl. No.: 13/435,952

(22) Filed: Mar. 30, 2012

Related U.S. Application Data
(60) Provisional application No. 61/470,846, filed on Apr. 1, 2011.

(51) Int. Cl. G06F 17/18; G01C 21/20

(52) U.S. Cl. CPC G06F 17/18; G01C 21/20
USPC 702/179

(57) ABSTRACT

A system with multiple sensors is managed to determine which sensors to utilize when forming an estimate of the system state. A list of active sensor subsets is formed from multiple sensors. The list of active sensor subsets is represented by a list of differing vectors with indices enumerating the sensors of each sensor subset. Noise is filtered from a measurement of each sensor. State and covariance for each sensor of the multiple sensors is estimated based on prior measurements. A quality of service (QoS) metric is calculated for each sensor subset based on the estimated sensor state. The QoS metric is recorded in a QoS vector and the list of active sensors subsets is updated with the sensor subsets that have a QoS metric above a QoS threshold. The state and covariance estimates are combined to form the estimates of the system state and covariance.

### CROSS-REFERENCE TO RELATED APPLICATIONS

This application claims the benefit of and priority to U.S. provisional patent application No. 61/470,846, filed Apr. 1, 2011, the entire contents of which are incorporated by reference herein.

### FIELD OF THE INVENTION

This invention relates generally to data fusion. The invention has been applied to tracking and navigation using multiple sensor reports to develop state estimates of the desired tracked object (e.g., a missile in the context of threat tracking or the best estimate of 6 degree-of-freedom platform state in the context of vehicle navigation).

### BACKGROUND

Advances in high-precision sensors of numerous modalities, the increasing availability and utilization of mature geospatial databases, and powerful embedded computing have enabled breakthrough capabilities for high precision positioning, navigation, and tracking for mobile systems, both manned and unmanned. Multi-sensor data fusion, combining information from the Global Positioning System (“GPS”), Inertial Measurement Units (“IMUs”), Radio Detection and Ranging (“Radar”) systems, Light Detection and Ranging (“LIDAR”) systems, and numerous other sensor types, can enable high-accuracy platform state estimation under challenging environmental and low signal/high clutter conditions. In the event of sensor quality of service (“QoS”) interruption, it is desirable that the navigation system detect the interruption, adapt rapidly to the information available, and rapidly approach a theoretical (e.g., Cramer-Rao) optimum in terms of performance.

When a sensor is undergoing a QoS interruption, the interruption is sometimes detectable by means of standard metrics. For example, the sensor report does not arrive at the processor at all (e.g., due to a sensor failure), or through a failure of a basic test of “goodness” such as an unfavorable level of noise in the measurement (e.g., due to wideband noise jamming). In these cases, the sensor measurement can be removed from the Kalman filter, provided that a means exists for dynamically adjusting the filter. However, in other cases (e.g., spoofing, decoys, non-stationary bias errors, etc.) the measurement may not show any obvious signs of its poor QoS. Poor sensor performance is only revealed in the eventual state estimate, and there may be no general way to figure out which sensor caused the error (e.g., which sensors are “lying” and which are “telling the truth”). The state covariance, itself, may not be the best representation of the true probability distribution of the state, and the implicit Gaussian (or at least univariate) assumption of a standard Kalman filter fails to accurately model a situation when there are two separate peaks due to a biased or erroneous measurements in some sensors.

An additional challenge is that generally optimal methods for data fusion of multiple sensors under realistic conditions (with bias errors, nonstationary/non-Gaussian noise, unknown platform motion models, nonlinear measurement and motion models, and rapid sensor dropouts or quality of service degradation) are not known, or are impractical. Current position and navigation systems are custom-built for suites of sensors specific to individual platforms and require extensive custom software development, customization, and tuning as a necessary integration step. A solution needs to be dynamically adaptable, and allow on-the-fly switching out sensors and/or measurement vector choices based on real-time quality of service information to make the best possible estimates of the desired state. Current sensor management functions are not general enough to dynamically discover selective sensor QoS interruptions and maintain good state estimation or tracking performance, e.g., maintain performance at or near the Cramer-Rao optimum for the remaining unaffected sensors.

Prior solutions provided basic data fusion methods using nonlinear tracking and measurement fusion. These methods have been implemented with Unscented Kalman Filters. There has also been work on sensor fault tolerance in navigation filtering. For example, a self-adaptive filter for the fusion of Inertial Navigation System (“INS”), GPS, Synthetic Aperture Radar (“SAR”), and an altimeter has been used. The self-adaptation system amounts to a down-select to a restricted (“local”) suite of sensors from the total (“global”) suite, under conditions of GPS service denial or other degradation. However, the self-adaption system does not generalize to arbitrary sensors.

Another example is a “redundant multi-mode filter” for navigation based on QoS metrics from the inertial sensors, the GPS, and other sensors. The result is a matrix of modes (tracking filters) which are selected based on the availability of certain sensors. Sensor error vectors are allowed to vary, but navigation state is always the same for any set of sensors. In the redundant multi-mode filter system, the mode selection criteria are pre-set rather than determined dynamically. This system does not allow for the tracking of multiple sensor subsets simultaneously.

### SUMMARY OF THE INVENTION

The invention, in various embodiments, features a method, apparatus and computer program product to estimate the state of a platform in the presence of highly variable quality of service and/or deliberate denial of service. Multiple parallel Kalman filters running on sensor subsets can be used. The possible subsets that are sufficient to produce state estimates are selected on the basis of observability criteria. The state estimates of the different subsets are compared to one another or to a master sensor set (the maximally inclusive sensor subset), and the errors of the state estimates are formed. Those errors are compared with previous records of the errors to determine whether a quality of service interruption for a particular sensor subset is underway. Based on that information, a set of sensors is selected for tracking various attributes of the platform, as well as for generating the next estimate of state and covariance.

In one aspect, there is a method of managing a system having multiple sensors to determine which sensors to utilize when forming an estimate of the system state. The method includes forming a list of active sensor subsets from the multiple sensors in the system. The list of active sensor subsets is represented by a list of one or more differing vectors. Each of the one or more differing vectors includes indices enumerating the sensors of an individual sensor subset. The method also includes filtering noise from a measurement of each sensor of the multiple sensors. A determination of an estimated state and an estimated covariance for each sensor of the multiple sensors is based on a prior measurement of each sensor of the multiple sensors. A quality of service metric for each sensor subset is calculated based on the estimated state of each sensor of the multiple sensors, and the quality of service metric is recorded in a quality of service vector. The list of active sensors subsets is updated with the sensor subsets that have a quality of service metric above a quality of service threshold, and the state estimate and the covariance estimate are combined to form the estimate of the system state and an estimate of the covariance of the system.

In another aspect, there is a method of managing a system with multiple sensors to determine which sensors are functioning properly. The method includes selecting all possible subsets of sensors that are sufficient based on an observability criterion to produce state estimates. A state estimate of a sensor subset is compared to other sensor subset state estimates or to a state estimate of a master sensor set containing all sensors of the multiple sensors. An error is formed for each sensor subset state estimate. The error is compared with a prior error to determine whether a quality of service interruption for a particular sensor subset is underway. A set of sensors is selected for use in tracking on the basis of the quality of service, and a next estimate of state and a next estimate of covariance are generated.

In another aspect, there is an apparatus for managing a system with multiple sensors to determine which sensors are functioning properly. The apparatus includes a fusion center configured to form a list of active sensor subsets from the multiple sensors in the system. The list of active sensor subsets represents a list of one or more differing vectors that includes indices enumerating the sensors of an individual sensor subset. The apparatus also filters noise from a measurement of each sensor of the multiple sensors and determines an estimated state and an estimated covariance for each sensor of the multiple sensors based on a prior measurement of each sensor of the multiple sensors. A quality of service metric is calculated for each sensor subset based on the estimated state of each sensor of the multiple sensors and recorded in a quality of service vector. The apparatus further updates the list of active sensors subsets with the sensor subsets that have a quality of service metric above a quality of service threshold and combines the state estimate and the covariance estimate to form the estimate of the system state and an estimate of the covariance of the system.

In another aspect, there is a computer program product, tangibly embodied in a non-transitory computer readable storage medium, for determining which sensors to utilize when forming an estimate of the system state. The computer program product includes instructions being operable to cause a data processing apparatus to form a list of active sensor subsets from the multiple sensors in the system, which is represented by a list of one or more differing vectors. The one or more differing vectors include indices enumerating the sensors of an individual sensor subset. Noise is filtered from a measurement of each sensor of the multiple sensors, and an estimated state and a covariance is estimated for each sensor of the multiple sensors based on a prior measurement of each sensor of the multiple sensors. The computer program product also includes instructions being operable to calculate a quality of service metric for each sensor subset based on the estimated state of each sensor of the multiple sensors, the quality of service metric being recorded in a quality of service vector and update the list of active sensors subsets with the sensor subsets that have a quality of service metric above a quality of service threshold. The state estimate and the covariance estimate are combined by the computer program product to form the estimate of the system state and an estimate of the covariance of the system.

Each aspect described above can include one or more of the following features. In some embodiments, forming the list of sensor subsets includes determining an observability value, based on an observability criteria, of each sensor of the multiple sensors. The observability value can be recorded in an observability vector. A covariance of the system state formed can be determined from each sensor of the multiple sensors, and the covariance can be recorded in a covariance matrix. The list of active sensor subsets that have both an observability value above an observability threshold and a trace of the covariance matrix below a covariance threshold can be recorded. Calculating the quality of service metric can include comparing the estimated state and the covariance matrices, and assigning a quality of service metric based on the comparison. The comparison can be calculated with a quality of service test.

In various embodiments, comparing the estimated state and the covariance matrices includes forming a new sensor difference state by taking a difference between the estimated state of each sensor of the multiple sensors and an estimated state for each sensor in the list of active sensor subsets. A variance of each sensor difference state can be computed from a corresponding sensor difference state in a past history buffered differential matrix. A statistical distance can be taken between each sensor difference state and the corresponding sensor difference state from the past history buffered differential matrix. The sensor difference state can be recorded in a past history buffered differential matrix, and determining the quality of service test can be based on a comparison of the statistical distance to a statistical distance threshold.

The statistical distance can be a Mahalanobis distance. The list of active sensors can be refreshed. The estimated state can also be based on an intentional action. Tracking the system can be done using a multiple hypothesis tracking (“MHT”) method. The filters can be, for example, Kalman filters, Unscented Kalman Filters, or Extended Kalman Filters. The observability value can be binary. Calculating the quality of service metric can include taking a set union of each sensor subset that failed the quality of service test, calculating which specific sensors had caused the failed quality of service test for the sensor subsets that had failed quality of service test, and reporting the specific sensors which are causing the failed quality of service test.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a fusion center including its inputs and outputs.

FIG. 2 is a flow diagram showing a process for combining sensor measurements and forming a state estimate that is robust to sensor QoS interruptions.

FIG. 3 is a flow diagram showing the initialization of the MSets, which determine all sets of measurements that can be used to generate state and covariance estimates.

FIG. 4 is a flow diagram showing a process for forming a quality of service vector and the associated information needed to determine which sensor subset to use for tracking.

FIG. 5 is a flow diagram showing a process for using the quality of service information to select from among the available measurement sets to form the state estimate and covariance estimate.

FIG. 6 shows possible subsets of sensors.

### DETAILED DESCRIPTION OF THE INVENTION

A modular set of sensors can be combined into a set of measurement suites (“MSets”), each of which is separately tracked with a Kalman filter. A fusion manager can form these sets, take the outputs of all of the parallel MSet filters and the raw measurements, and combine them into a fused estimate of state and covariance.

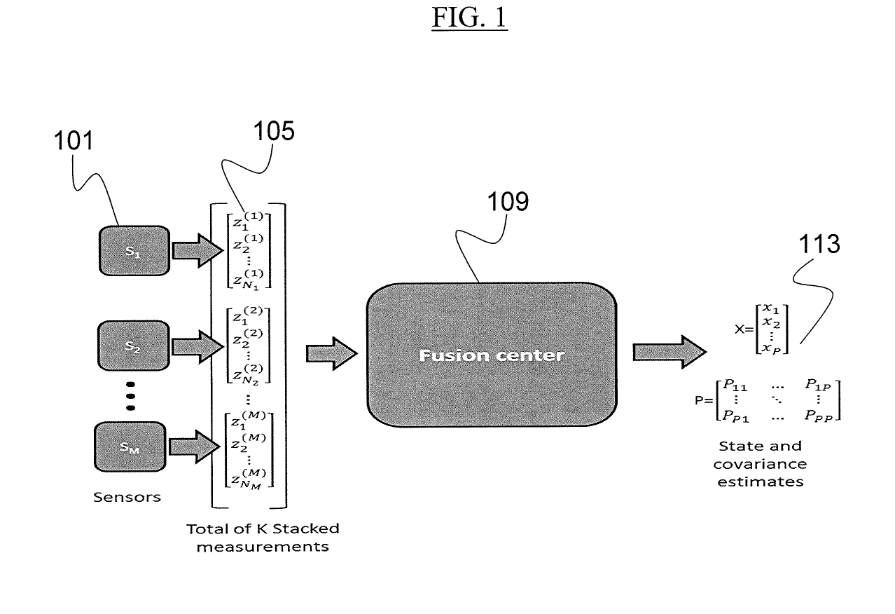

In FIG. 1, the full set of M sensors 101 produce an independent set of measurements, which can contribute to a full set of K measurements zₖ 105. For example, one sensor can produce range estimates, another can produce angle (e.g., azimuth or elevation) estimates, and a third can produce a measurement of a desired state estimate (e.g., orthonormal coordinates x, y, z, vₓ, v_{y}, v_{z}). The measurements of all sensors can be introduced to the sensor management and fusion center 109. State and covariance estimates 113 of dimension P can be estimated as an output from the proposed invention.

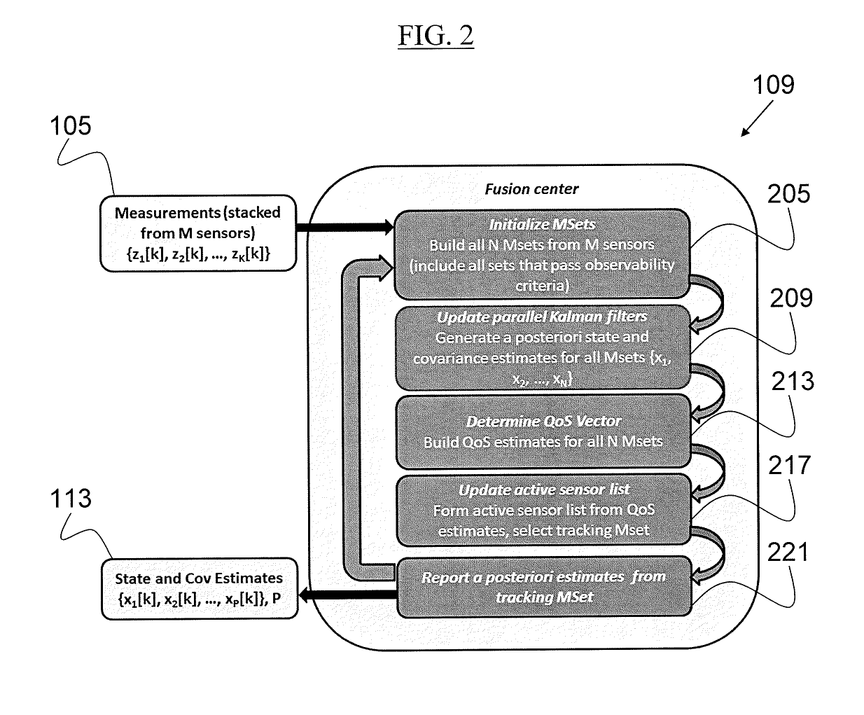

FIG. 2 shows a flow diagram for the fusion center of the fusion center 109. As shown in FIG. 1, the fusion center 109 takes in as inputs the full set of K measurements zₖ 105 and outputs the state and covariance estimates 113. A first step 205 initializes Msets that have instances denoted as Sₙ, where n={1, . . . N<=2^{M}}. The first step 205 can enumerate the number of MSets. A MSet is a specific subset of the all measurements zₖ (Note the number of MSets is less than 2^{M}, since that is the maximum number of subsets mathematically possible. This firmly bounds the maximum number of multiple hypotheses developed in subsequent steps). Valid MSets are those that are capable of producing useful state estimates, and this validity can be determined in a number of ways. A second step 209 updates parallel filters by generating a state and covariance estimate. A third step 213 determines a QoS vector that contains QoS estimates of all the MSets. A fourth step 217 updates an active sensor list. A fifth step 221 updates the state and covariance estimates 113.

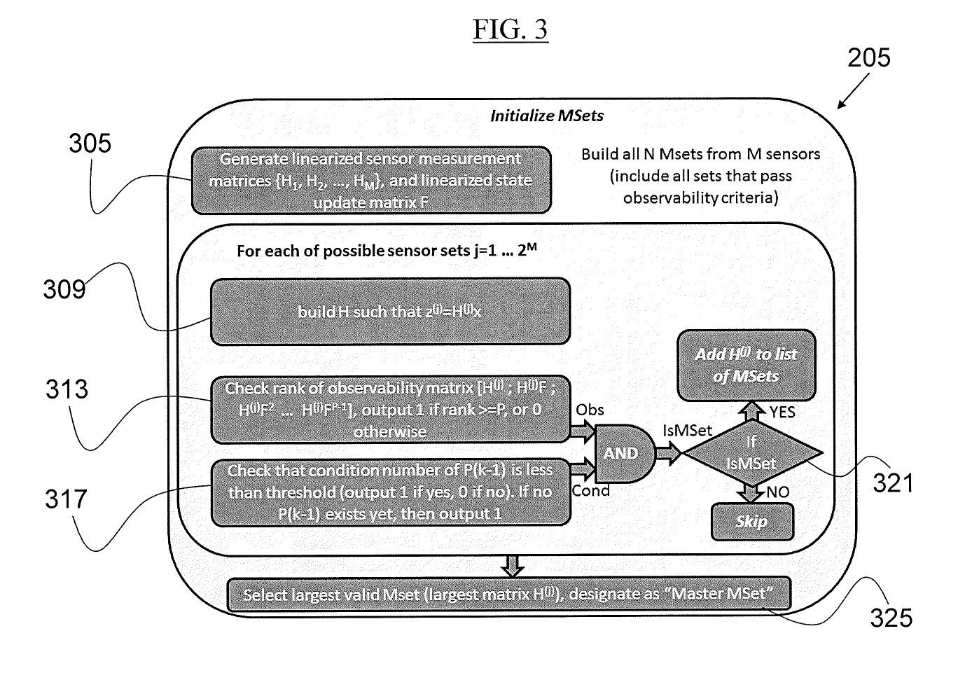

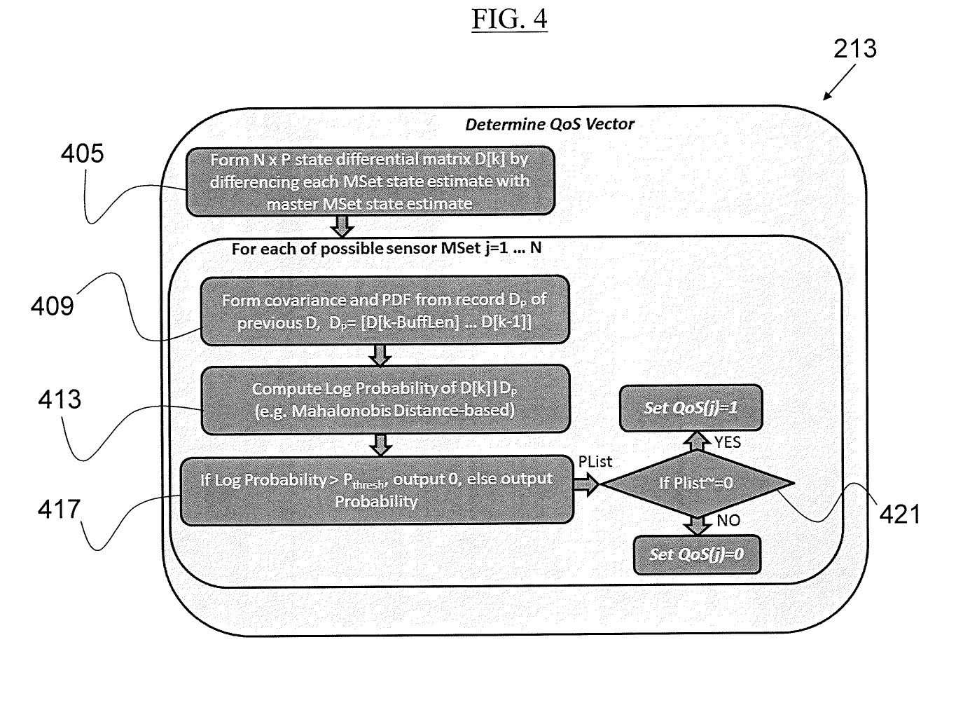

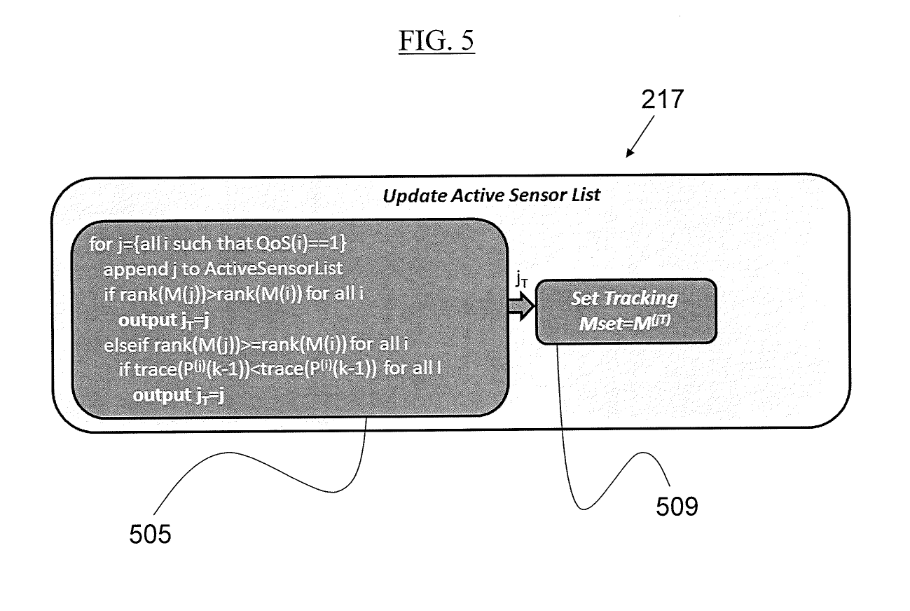

The first step 205 is further described in the discussion of FIG. 3. The second step 209 is described after the FIG. 3 discussion. The third step 213 is described in the discussion of FIG. 4. The fourth step 217 is described in the discussion of FIG. 5. The fifth step 221 not only outputs the state and covariance estimates 113 of FIG. 1, but it also can allow those state and covariance estimates 113 to be used in subsequent initializations of Msets (e.g., the first step 205).

FIG. 3 shows the first step 205 for initializing MSets. In this implementation, all N Msets are built from M sensors in step 305 by generating linearized sensor measurement matrices {H₁, H₂, . . . , H_{M}} and linearized state update matrix F (including all sets that pass an observability criteria). The MSets are selected by first stepping through every possible measurement subset (e.g., for each possible sensor sets j=1 . . . 2^{M}). According to step 309, if x is a state of the system (e.g., a position value), and z is a measurement related to the state of the system, then H is a linearized sensor measurement matrix that can be built to map x to z in order to figure out unknown variables. Step 309 can be represented by the following equation: z^{ω}=H^{ω}x. The Msets are then evaluated based on the conditional number of the covariance relative to a threshold (e.g., step 313) and the rank of the observability matrix relative to the state dimension P (e.g., step 309). The threshold is a value that can either be preset or defined as the first step 205 is used. In step 321, those measurement subsets that meet both conditions are selected to be included in a list of the MSet. However, if both conditions are not met, the measurement subsets can be skipped, or not included, in the list of the MSet. The first time the MSet is run, there will not yet be any covariance estimate, and so the observability matrix alone can determine inclusion. The end result of this step can be the MSets that are candidates for providing input into an eventual fused state estimate. In step 325, the largest MSet (as determined by the rank of the MSets) can be selected as a “Master MSet.”

As shown in the second step 209 of FIG. 2, the next step in the flow diagram of the fusion center 109, following the initialization of MSets in the first step 205, is a recursive tracking loop. N state estimates are generated in time by running a Kalman filter, such as an unscented Kalman filter, on each of the MSets in parallel. This produces a full P-dimensional state estimate xⁿ for each of the N MSets. However, any kind of Kalman filter can be used to generate the N state estimates.

The third step 213 for determining a QoS vector is shown in FIG. 4. A QoS vector (with a length of N) is produced for all of the MSets. This can be a binary vector that captures whether a given MSet is a candidate for producing a fused state estimate. Sensors that are experiencing QoS interruptions can be detected by comparing their estimates with other sensor subsets. Based on the comparison, a determination can be made regarding which MSet can be used for tracking. The determination can be based on a probability distribution function.

The difference between the state estimates of each of the MSets from the master MSet is used to form a N×P state differential matrix D (Step 405). In step 409, for each possible sensor MSet, a covariance and a probability distribution function is formed from a buffer set of older D's. The current D for each MSet is then compared to the probability distribution constructed to detect when that MSet begins to deviate in a significant manner from the other Msets (Step 413). One way to do this can be to use the statistical (e.g., Mahalonobis) distance of each element of the D matrix (each of those is a P vector) from a covariance matrix generated from a previously buffered matrix (of size N×N×P×L) where L is the length of the buffer. Other way can include using any distance metric (e.g., any metric that can be used to determine a distance between elements of a set). The probability of the observed state error conditioned on the previously observed state errors is compared with a threshold. The probability can then be output into a vector as shown in step 417 of FIG. 4. The output of this function can be a vector of N QoS estimates. In some embodiments, QoS estimates are near zero if the quality of service is low and further from zero (e.g., nearer to 1) if the quality of service is good. The QoS estimates can be set in Step 421. The raw probabilities that a sensor is working is listed in each element of the P vector (“Plist”) can also be output (Step 417). A Plist can be used to track which sensors are active based on whether measurements tend to indicate that there is some sort of agreement between the measurements of other sensors. In other embodiments, step 421 can set the QoS estimates to be 1 if the Plist value is around zero and 0 if the Plist value is not around zero. In other words, the QoS estimate is set to low if there is a low probability that a sensor is working and high if there is a probability that a sensor is working.

The active sensor list can be updated based on the QoS, the Plist, and/or other quality of service metrics. An MSet can be selected based on a threshold of the Plist for use as the tracking estimator, and a state and covariance matrix can be output. Rather than selecting a particular MSet according to maximum QoS, the estimates of state and covariance for multiple MSets can also be combined according to a weighted average, with the weighing given by the Plist value. Estimates of state and covariance that appear to be more reliable are given more consideration than unreliable ones. This can help neutralize or ignore outlier estimates from incorrect sensor measurements.

FIG. 5 shows the fourth step 217 for updating the active sensor list. The active MSet is selected based on having a non-zero QoS and a maximally ranked measurement matrix in step 505. The state and the covariance from the selected MSet are then reported out of the fusion center as the “fused estimate” in Step 509.

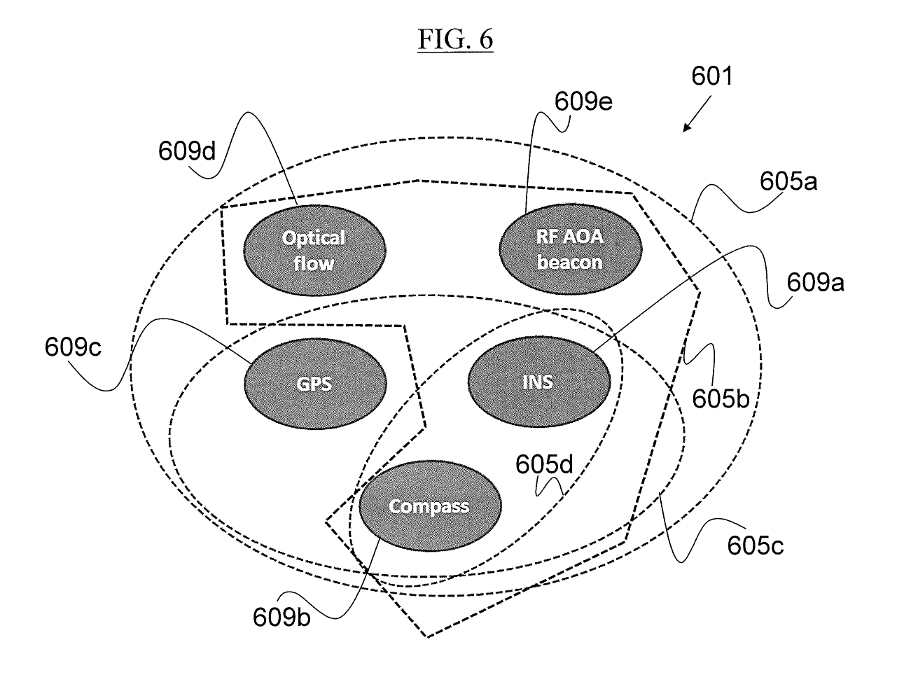

FIG. 6 shows a modular set of sensors 601 that includes individual sensors 609a-e. Each MSet 605a-605d can include at least one sensor of the modular set of sensors. A MSet can also include all of the modular set of sensors (e.g., MSet 605a). A sensor of the modular set of sensors can also be a part of multiple Msets (e.g., Sensor 609a is a part of MSet 605c and MSet 605d).

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (IC), DSP, FPGA or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks. Communication networks can also all or a portion of the PSTN, for example, a portion owned by a specific carrier.

The computing system can include clients and servers. A client and server are generally remote from each other and typically interact through a communication network. The relationship of client and server arises by virtue of computer programs running on the respective computers and having a client-server relationship to each other.

While the invention has been particularly shown and described with reference to specific illustrative embodiments, it should be understood that various changes in form and detail may be made without departing from the spirit and scope of the invention.

What is claimed is:

1. A method of managing a system having multiple sensors to determine which sensors to utilize when forming an estimate of the system state, the method comprising:
forming a list of active sensor subsets from the multiple sensors in the system, the list of active sensor subsets being represented by a list of one or more differing vectors, each of the one or more differing vectors including indices enumerating the sensors of an individual sensor subset;
filtering noise from a measurement of each sensor of the multiple sensors;
determining an estimated state and an estimated covariance for each sensor of the multiple sensors based on a prior measurement of each sensor of the multiple sensors;
calculating a quality of service metric for each sensor subset based on the estimated state of each sensor of the multiple sensors, the quality of service metric being recorded in a quality of service vector;
updating the list of active sensors subsets with the sensor subsets that have a quality of service metric above a quality of service threshold; and
combining the state estimate and the covariance estimate to form the estimate of the system state and an estimate of the covariance of the system.

2. The method of claim 1 wherein forming the list of sensor subsets further comprises:
determining an observability value, based on an observability criteria, of each sensor of the multiple sensors, the observability value being recorded in an observability vector;
determining a covariance of the system state formed from each sensor of the multiple sensors, the covariance being recorded in a covariance matrix; and
recording the list of active sensor subsets that have both an observability value above an observability threshold and a trace of the covariance matrix below a covariance threshold.

3. The method of claim 2 wherein calculating the quality of service metric further comprises:
comparing the estimated state and the covariance matrices; and
assigning a quality of service metric based on the comparison, the comparison calculated with a quality of service test.

4. The method of claim 3 wherein comparing the estimated state and the covariance matrices comprises:
forming a new sensor difference state by taking a difference between the estimated state of each sensor of the multiple sensors and an estimated state for each sensor in the list of active sensor subsets;
computing a variance of each sensor difference state from a corresponding sensor difference state in a past history buffered differential matrix;
taking a statistical distance between each sensor difference state and the corresponding sensor difference state from the past history buffered differential matrix;
recording the sensor difference state in a past history buffered differential matrix; and
determining the quality of service test based on a comparison of the statistical distance to a statistical distance threshold.

5. The method of claim 4 wherein the statistical distance can be a Mahalanobis distance.

6. The method of claim 1 further comprising refreshing the list of active sensors.

7. The method of claim 1 wherein the estimated state can also be based on an intentional action.

8. The method of claim 1 further comprising tracking the system using a multiple hypothesis tracking (“MHT”) method.

9. The method of claim 1 wherein the filters are Kalman filters, Unscented Kalman Filters, or Extended Kalman Filters.

10. The method of claim 2 wherein the observability value is binary.

11. The method of claim 3 wherein calculating the quality of service metric further comprises:
taking a set union of each sensor subset that failed the quality of service test;
calculating which specific sensors had caused the failed quality of service test for the sensor subsets that had failed quality of service test; and
reporting the specific sensors which are causing the failed quality of service test.

12. A method of managing a system with multiple sensors to determine which sensors are functioning properly, the method comprising:
selecting all possible subsets of sensors that are sufficient based on an observability criterion to produce state estimates;
comparing a state estimate of a sensor subset to other sensor subset state estimates or to a state estimate of a master sensor set containing all sensors of the multiple sensors;
forming an error for each sensor subset state estimate;
comparing the error with a prior error to determine whether a quality of service interruption for a particular sensor subset is underway;
selecting a set of sensors for use in tracking on the basis of the quality of service; and
generating a next estimate of state and a next estimate of covariance.

13. An apparatus for managing a system with multiple sensors to determine which sensors are functioning properly, the apparatus comprising a fusion center configured to:
form a list of active sensor subsets from the multiple sensors in the system, the list of active sensor subsets being represented by a list of one or more differing vectors, each of the one or more differing vectors including indices enumerating the sensors of an individual sensor subset;
filter noise from a measurement of each sensor of the multiple sensors;
determine an estimated state and an estimated covariance for each sensor of the multiple sensors based on a prior measurement of each sensor of the multiple sensors;
calculate a quality of service metric for each sensor subset based on the estimated state of each sensor of the multiple sensors, the quality of service metric being recorded in a quality of service vector;
update the list of active sensors subsets with the sensor subsets that have a quality of service metric above a quality of service threshold; and
combine the state estimate and the covariance estimate to form the estimate of the system state and an estimate of the covariance of the system.

14. A computer program product, tangibly embodied in a non-transitory computer readable storage medium, for determining which sensors to utilize when forming an estimate of the system state comprising, the computer program product including instructions being operable to cause a data processing apparatus to:
form a list of active sensor subsets from the multiple sensors in the system, the list of active sensor subsets being represented by a list of one or more differing vectors, each of the one or more differing vectors including indices enumerating the sensors of an individual sensor subset;
filter noise from a measurement of each sensor of the multiple sensors;
determine an estimated state and an estimated covariance for each sensor of the multiple sensors based on a prior measurement of each sensor of the multiple sensors;
calculate a quality of service metric for each sensor subset based on the estimated state of each sensor of the multiple sensors, the quality of service metric being recorded in a quality of service vector;
update the list of active sensors subsets with the sensor subsets that have a quality of service metric above a quality of service threshold; and
combine the state estimate and the covariance estimate to form the estimate of the system state and an estimate of the covariance of the system.
